(19) United States
(12) Patent Application Publication
(10) Pub. No.: US 2008/0267220 A1
(43) Pub. Date: Oct. 30, 2008

(54) Method of Iterative Signal Processing For Cdma Interference Cancellation and Ising Perceptrons

(75) Inventors: David Saad, West Midlands (GB); Juan Pablo Neirotti, West Midlands (GB)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Aston University, Birmingham (GB)

(21) Appl. No.: 11/886,445

(22) PCT Filed: Mar. 16, 2006
(86) PCT No.: PCT/GB2006/000976

§ 371 Date: Sep. 14, 2007

(30) Foreign Application Priority Data
Mar. 16, 2005 (GB) 0505354.1

(51) Int. Cl. H04J 13/00

(52) U.S. Cl. 370/479

(57) ABSTRACT

A method of processing a signal to infer a information encoded in the signal, measuring characteristics of the signal, making an estimate of the information from measured signal characteristics, using an expanded set of information, the expanded set of information being correlated to the measured signal characteristics, determining an update rule and applying the update rule to the expanded set of information to generate an inferred set of information representative of that encoded in the signal. The method may be used in many applications, for example inferring information in CDMA signals, learning in an Ising perceptron and lossy compression.

### FIELD OF INVENTION

This invention relates to a method of signal processing, particularly but not exclusively for processing a Code Division Multiple Access (CDMA) signal.

### BACKGROUND TO THE INVENTION

Signal processing finds application in a wide variety of technical fields, such as in telecommunications, in neural networks and in data compression. When information is encoded into a signal, a common problem in signal processing is how to determine this information given some measured characteristics of the signal. This is typically performed by finding the solution which maximises the posterior probability (the probability of the information given the signal characteristics).

Pearl (Probabilistic Reasoning in Intelligent Systems, Morgan Kaufmann Publishers, San Francisco, Calif., 1988), Jensen (An Introduction to Bayesian Networks, UCL Press, London, 1996) and MacKay (Information Theory, Inference and Learning Algorithms, Cambridge University Press, 2003) describe graphical models for the statistical dependence between acquired data and an iterative method for inferring the data from a signal, known as Belief Propagation (BP). When the graphical model comprises loops, there is no guarantee that the method will converge to the original information, although Weiss (Neural Computation 12 1, 2000) provides some theory to show when this will occur in restricted cases. When the space of solutions is contiguous, BP typically provides good performance.

BP has been extended by Mézard, Parisi and Zecchina (Science 297 812, 2002) to the case where the space of solutions is fragmented and for problems that can be mapped onto sparse graphs.

Kabashima (J. Phys A 36 11111, 2003) describes a technique for inference of the information given a signal, based on passing condensed messages between variables, consisting of averages over grouped messages. This technique works well in cases where the solution space is contiguous. However, the technique does not work where there are many possible competing solutions, which is characteristic of a fragmented solution space; the emergence of competing solutions would typically prevent the iterative algorithm from converging. Problems in the area of signal processing often present such behaviour, for some values of certain key parameters which may be known or unknown.

### SUMMARY OF INVENTION

The present invention seeks to provide an improved method of signal processing, against this background. The present invention provides a method of processing a signal to infer a first data set encoded therein, the method comprising the steps of measuring a plurality of characteristics of the signal; establishing a plurality of correlation matrices, each correlation matrix comprising a plurality of correlation values; generating second and third data sets; determining an update rule relating each datum of the second and third data sets to each other respective datum of the second and third data sets by way of the measured signal characteristics and the properties of the correlation matrix; applying the update rule to the second and third data sets to obtain updated second and third data sets; and generating an inferred data set representative of the encoded first data set from the updated second and third data sets.

Preferably, the method further comprises the steps of: determining a plurality of likelihoods, each likelihood comprising the probability of a signal characteristic given the first data set, with respect to a free parameter; and optimising the free parameter with respect to a predefined cost measure.

In a further aspect the invention provides an inference method for solving a physical problem mapped onto a densely connected graph, where the number of connections per variable is of the same order as the number of variables, comprising the steps of: (a) forming an aggregated system comprising a plurality of replicated systems, each of which is conditioned on a measurement obtained from a physical system, with a correlation matrix representing correlation among the replicated systems; (b) expanding the probability of the measurements given the solutions obtained by the replicated systems; (c) based on the expansion of the step (b), deriving a closed set of update rules, which are capable of being calculated iteratively on the basis of results obtained in a previous iteration, for a set of conditional probability messages given the measurements; (d) optimising free parameters which emerge from at least one of the steps (b) and (c) for the specific problem examined with respect to a predefined cost measure; (e) using the optimised parameters to derive an optimised set of update rules for the conditional probability messages given the measurements; (f) applying the update rules iteratively until they converge to a set of substantially fixed values; and (g) using the substantially fixed value to determine a most probable state of the variables.

Preferably, step (b) of the inference method comprises expanding the likelihood in the large number limit. Preferably, the inference method further comprises the further subsequent step of deriving from the optimised set a posterior estimate.

By the use of a correlation matrix, the method of the present invention permits the determination of a probability per datum, averaged over a plurality of correlated estimates. As a result of the optimisation with respect to a predefined cost, the value of an unknown, free parameter can be ascertained. This free parameter is an unknown characteristic of the signal, which in signal processing applications, may be any parameterised unknown introduced as a result of earlier processing of the signal, for instance, the introduction of noise and interference in a communication system, noisy inputs to a system in a neural network, or controlled distortion in a data compression system.

The invention finds application in various fields of signal processing. For example, in the field of Code Division Multiple Access (CDMA) it is possible to determine the probability of the original information (estimate) given the plurality of signal characteristics, such that the noise level which was previously unknown, can be ascertained. Estimation of noise is an important problem in signal detection for a communication system. This determination advantageously allows the detector itself to calculate a value for noise level and thereby reduces the probability of error in the detected information.

### BRIEF DESCRIPTION OF THE DRAWINGS

FIG. 1 is a schematic diagram illustrating a known type of coded division multiple access system to which a method contributing an embodiment of the invention may be applied;

FIG. 2 is a diagram illustrating a signal detection problem of the system of FIG. 1 as a bipartite graph;

FIGS. 4 and 5 are flow diagrams illustrating a method constituting an embodiment of the invention.

FIG. 3 comprises a plurality of graphs comparing the performance of a method constituting an embodiment of the invention with that of a know method.

### SPECIFIC DESCRIPTION OF A PREFERRED EMBODIMENT

The present techniques may be applied to a broad range of applications, for example including inference in discrete systems and decoding in error-correction and compression schemes as described by Hosaka, Kabashima and Nishimori (Phys. Rev E 66 066126, 2002).

However, a specific example of an application to acquiring a data set from a Code Division Multiple Access (CDMA) signal will now be described by way of example only.

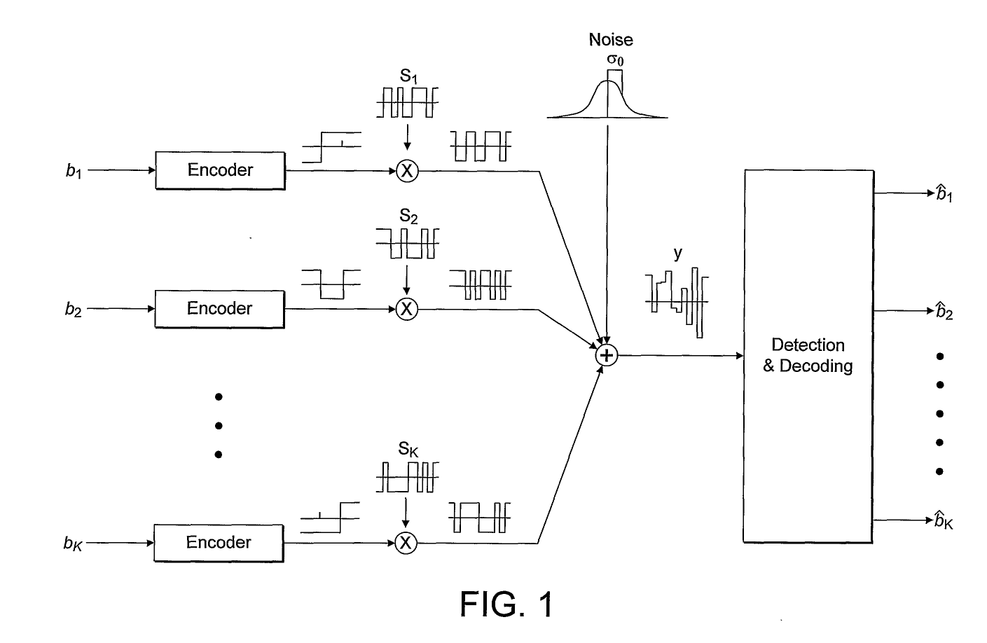

Multiple access communication refers to the transmission of multiple messages to a single receiver. In the system shown in FIG. 1, there are K users transmitting independent messages over an additive white Gaussian noise (AWGN) channel of zero mean and variance σ₀². Various Division Multiple Access methods are known for separating the messages, in particular Time, Frequency and Coded Division Multiple Access as described by Verdú (Multiuser Detection, Cambridge University Press UK, 1998). Although CDMA, applied to mobile telephony, is currently used mainly in Japan and South Korea, its advantages over TDMA and FDMA make it a promising alternative for future mobile communication elsewhere.

In the CDMA system of FIG. 1, K independent messages bₖ are spread by codes sₖ of spreading factor N and are transmitted simultaneously through an Additive White Gaussian Noise (AWGN) channel. From the received signal y, a set of estimates {\hat{b}ₖ} are obtained by the decoding algorithm.

A technique for detecting and decoding such messages is based on passing probabilistic messages between variables in a problem mapped onto a dense graph. Passing these messages directly, as separately suggested by Pearl, Jensen and Mackay, is infeasible due to the prohibitive computational costs. The technique disclosed in Kabashima based on passing condensed messages between variables, consisting of averages over grouped messages, works well in cases where the space of solutions is contiguous and iterative small changes will result in convergence to the most probable solution. However, this technique does not work where there are many possible competing solutions; the emergence of competing solutions would typically prevent the iterative algorithm from converging. This is the situation in signal detection in CDMA.

CDMA is based no spreading the signal by using K individual random binary spreading codes of spreading factor N. We consider the large-system limit, in which the number of users K is large (tends to infinity) while the system load β≡K/N is kept to be O(1) (of order 1). We focus on a CDMA system using binary shift keying (BPSK) symbols and will assume the power is completely controlled to unit energy. The received aggregated, modulated and corrupted signal is of the form

$${y}_{μ} = \frac{1}{\sqrt{N}} {\sum }_{k = 1}^{K} {s}_{μ k} {b}_{k} + {σ}_{0} {n}_{μ}$$

where bₖ is the bit transmitted by user k, s_{μk} is the spreading chip value, n_{μ} is the Gaussian noise variable drawn from N (0,1), and y_{μ} the received message (FIG. 1).

The goal is to obtain an accurate estimate if the vector b for all users given the received message vector y by approximating the posterior P (b|y) (probability of b given y). A method for obtaining a good estimate of the posterior probability in the case where the noise level is accurately known has been presented in Kabashima. However, the calculation is based on finding a single solution and is therefore bound to fail when the solution space becomes fragmented, for instance when the noise level is unknown, case that is of high practical value.

The reason for the failure in this case can be qualitatively understood by the same arguments as in the case of sparse graphs; the existence of competing solutions results in inconsistent messages and prevents the algorithm from converging to an accurate estimate. An improved solution can therefore be obtained by averaging over the different solutions, inferred from the same data, in a manner reminiscent of the SP approach, only that the messages in the current case are more complex.

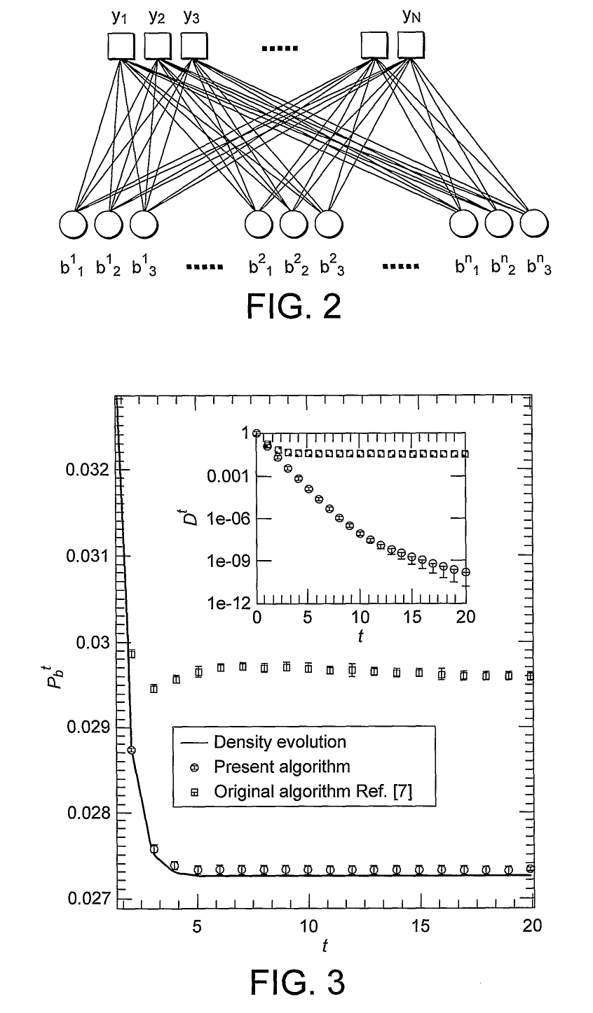

FIG. 2 shows the detection problem we aim to solve as a bipartite graphs where B (b₁, b₂, . . . , b_{K}) the set of bit vectors, bₖ=(bₖ¹, bₖ², . . . , bₖⁿ), where n is the solution (replica) index. Vector notation refers to the replicated solution index 1 . . . n (n→∞) and sub-index refer to the system nodes, given data y₁, y₂, . . . , y_{N}.

Using Bayes rule one obtains the BP equations (1):

$${P}^{t + 1} ( {y}_{μ} \vert {b}_{k} , \{ {y}_{v \neq μ} \} ) = {\hat{a}}_{μ k}^{t + 1} {Tr}_{\{ {b}_{l \neq k} \}} P ( {y}_{μ} \vert B ) {\prod }_{l \neq k}^{ } {P}^{t} ( {b}_{l} \vert \{ {y}_{v \neq μ} \} )$$

$${P}^{t} ( {b}_{l} \vert \{ {y}_{v \neq μ} \} ) = {a}_{μ k}^{t} {\prod }_{v \neq μ} {P}^{t} ( {y}_{v} \vert {b}_{l} , \{ {y}_{σ \neq v} \} )$$

where â_{μk}^{t+1} and a_{μk}^{t} are normalization constants. For calculating the posterior (2)

$$P ( B \vert y ) = \frac{{\prod }_{μ = 1}^{N} P ( {y}_{μ} \vert B )}{{Tr}_{\{ B \}} {\prod }_{μ = 1}^{N} P ( {y}_{μ} \vert B )} ,$$

an expression representing the likelihood is required and is easily derived from the noise model (which is not necessarily identical to the true noise) (3)

$$P ( {y}_{μ} \vert 𝔹 ) = \frac{1}{\sqrt{2 {πσ}^{2}}} exp \{ - \frac{{( {y}_{μ} - {Δ}_{μ} )}^{T} 𝕀 ( {y}_{μ} - {Δ}_{μ} )}{2 {σ}^{2}} \} ,$$

where y_{μ}=y_{μ}u and u^{T}≡1, 1, . . . , 1 (n dimensional)

$${Δ}_{μ} ≡ \frac{1}{\sqrt{N}} {\sum }_{k = 1}^{K} {s}_{μ k} {b}_{k} .$$

An explicit expression for inter-dependence between solutions is required for obtaining a closed set of update equations. We assume a dependence of the form (4)

$${P}^{t} ( {b}_{k} \vert \{ {y}_{v \neq μ} \} ) ∝ exp \{ {h}_{μ k}^{tT} {b}_{k} + \frac{1}{2} {b}_{k}^{T} {ℚ}_{μ k}^{t} {b}_{k} \} ,$$

where h_{μk}^{t} is a vector representing an external field and is the matrix of cross-replica correlations. Furthermore, we assume the following symmetry between replica (5):

$$\begin{matrix}{( {ℚ}_{μ k}^{t} )}^{ab} = {δ}^{ab} {q}_{μ k}^{t} + ( 1 - {δ}^{ab} ) {p}_{μ k}^{t} \\ {h}_{μ k}^{t} = {h}_{μ k}^{t} u .\end{matrix}$$

An expression for equation (4) immediately follows

$${P}^{t} ( {b}_{k} \vert \{ {y}_{v \neq μ} \} ) = {[ {Z}_{μ k}^{t} ]}^{- 1} ( {h}_{μ k}^{t} , {q}_{μ k}^{t} , {p}_{μ k}^{t} ) exp \{ {h}_{μ k}^{t} {\sum }_{a = 1}^{n} {b}_{k}^{a} + \frac{1}{2} {{p}_{μ k}^{t} ( {\sum }_{a = 1}^{n} {b}_{k}^{a} )}^{2} \} ,$$

where Z_{μk}^{t} is a normalization constant.

We expect the free energy obtained from the well behaved distribution P^{t} to be self-averaging, from which one deduces the following scaling laws: h˜O(1) and p˜O(n⁻¹). In the remainder of the application we will rescale the off-diagonal elements of Q_{μk}^{t} to g_{μk}^{t}/n, where g_{μk}^{t}˜O(1).

To calculate correlation between replica we expand P (y_{μ}|B) (Eq. 3) in the large N limit, where N is much larger than 1 and where inaccuracies occurring due to the approximation taken are negligible, as in Kabashima, to obtain (6):

$$P ( {y}_{μ} \vert 𝔹 ) ≃ C exp \{ - \frac{{( {y}_{μ} - {Δ}_{μ k} )}^{T} 𝕀 ( {y}_{μ} - {Δ}_{μ k} )}{2 {σ}^{2}} \} [ 1 + \frac{{s}_{μ k}}{\sqrt{N} {σ}^{2}} {( {y}_{μ} - {Δ}_{μ k} )}^{T} {b}_{k} , ]$$

where

$$Δ μ k = \frac{1}{\sqrt{N}} {\sum }_{l \neq k} {s}_{μ l} {b}_{l} ,$$

σ is an estimate on the noise and C is a constant. Using the law of large numbers as outlined by Spiegel, Schiller and Srinivasan (Schaum's Outline of Probability and Statistics, Schaum N.Y., 2000) we expect the variables Δμk to obey a Gaussian distribution.

The mean value of bₖ^{a} at time of t+1 is then given by (7):

$${\hat{m}}_{μ k}^{t + 1} = {( {σ}^{2} + β ( 1 - {Q}_{μ k}^{t} ) + β {ϒ}_{μ k}^{t} )}^{- 1} {( \frac{{y}_{μ} {s}_{μ}}{\sqrt{N}} - β ( {ℙ}_{μ} - {K}^{- 1} 𝕀 ) {m}_{μ}^{t} )}_{k} ,$$

where (P_{μ})ₖ₁≡(1/K) s_{μk}s_{μl} and (I)ₖ₁≡δₖₗ respectively. m_{μk}^{t}, Q_{μk}^{t} and Y_{μk}^{t} are (8), (9):

$${m}_{μ k}^{t} ≃ tanh ( {\sum }_{v \neq μ}^{N} {\hat{m}}_{vk}^{t} )$$

$${Q}_{μ k}^{t} ≃ \frac{1}{K} {\sum }_{l \neq k} {( {m}_{μ k}^{t} )}^{2}$$

$${ϒ}_{μ k}^{t} ≃ \frac{4}{K} {\sum }_{l \neq k} {( {n}_{μ k}^{t} {m}_{μ k}^{t} )}^{2} ,$$

where n_{μk}^{t} are free parameters related to the location of dominant terms in the probability P (y_{μ}|B).

The main difference between Eq. (7) and the equivalent in Kabashima is the emergence of an extra term in the prefactor, βY_{μk}^{t}, reflecting correlations between different solutions groups (replica). To determine this term we optimise the choice of Y_{μk}^{t} by minimising the bit error at each time step. Optimizing the inference error probability P_{b}^{t} at any time with respect to Y_{μk}^{t} one obtains straightforwardly that Y^{t}=(σ₀²−σ²)/β which is just a constant. However, it holds the key to obtaining accurate inference results. If our noise estimate is identical to the true noise the term vanishes and one retrieves the expression of Kabashima; otherwise, an estimate of the difference between the two noise values is required for computing \hat{m}_{μk}^{t+1}.

As a byproduct of the optimisation of Y^{t}, we found that the Equation (7) can be expressed as (10), (11):

$${A}^{t} ≃ {\{ \frac{1}{N} {\sum }_{μ = 1}^{N} {y}_{μ}^{2} - β {Q}^{t} \}}^{- 1}$$

$${\hat{m}}_{μ k}^{t + 1} = {{A}^{t} ( \frac{{y}_{μ} {s}_{μ}}{\sqrt{N}} - β ( {ℙ}_{μ} - {K}^{- 1} 𝕀 ) {m}_{μ}^{t} )}_{k}$$

where no estimate on σ₀ is required.

The estimate at the t-th iteration on the kth bit \hat{b}ₖ^{t} is then approximated by (12):

$${\hat{b}}_{k}^{l} ≃ sgn ( {\sum }_{μ = 1}^{N} {\hat{m}}_{μ k}^{t} )$$

The inference algorithm requires an iterative update of Equations (8, 9, 10, 11, 12) and converges to a reliable estimate of the signal, with no need for an accurate prior information of the noise level. The computational complexity of the algorithm is of O (K²).

To demonstrate the performance of our algorithm, we carried out a set of experiments of the CDMA signal detection problem under typical conditions. Error probability of the inferred signals has been calculated for a system of β=0.25, where the true noise level is σ₀²=0.25 and the estimated noise is σ²=0.01, as shown in FIG. 3. Squares represent results of the known algorithm (Kabashima) and the solid line the dynamics obtained from our equations; circles represent results obtained from the suggested practical algorithm. Variances are smaller than the symbol size. In the inset, D^{t} is a measure of convergence in the obtained solutions, as a function of time; symbols are as in the main figure.

The solid line represents the expected theoretical results (density evolution), knowing the exact values of the σ₀² and σ², while circles represent simulation results obtained via the suggested practical algorithm, where no such knowledge is assumed. The results presented are based on 10⁵ trials per point and a system size N=2000 and are superior to those obtained using the original algorithm (Kabashima).

Another performance measure one should consider is

$${D}^{t} ≡ \frac{1}{K} ( {m}^{t} - {m}^{t - 1} ) \cdot ( {m}^{t} - {m}^{t - 1} )$$

This provides an indication of the stability of the solutions obtained. In the inset of FIG. 3, we see that the results obtained from our algorithm show convergence to a reliable solution in stark contrast to the known algorithm (Kabashima). The physical interpretation of the difference between the two results is believed to be related to the improved ability to find solutions even in cases where the solution space is fragmented.

The CDMA signal detection problem is described by way of example only and without limiting the generality of the method. Similar inference methods could be obtained using the same principles for a variety of inference problems that can be mapped onto dense graphs. In a general method:

1. The generic inference approach is based on considering a large number of replicated solution systems (which is much larger than 1 and where inaccuracies occurring due to the approximation taken are negligible), each of which is conditioned on the same observations;
2. A correlation matrix of some form between replicated solutions is assumed;
3. The likelihood of observations given the replicated set of solutions is expanded using the large system size;
4. A closed set of updated rules for a set of conditional probabilities of messages given data is then derived;
5. Free parameters that emerge from the calculations are optimised.

These are the main steps of a generic derivation of a method of using belief propagation in densely connected systems that enables one to obtain reliable solutions even when the solution space is fragmented. The update rules which are obtained are applied iteratively until they converge until a set of substantially fixed values. In this context, “substantially fixed” is intended to mean that the values fulfil one or more criteria for convergence. For example, such a set of criteria may be that the values change by less than respective threshold amounts for consecutive iterations. These values are then used to determine the most probable states of the variables.

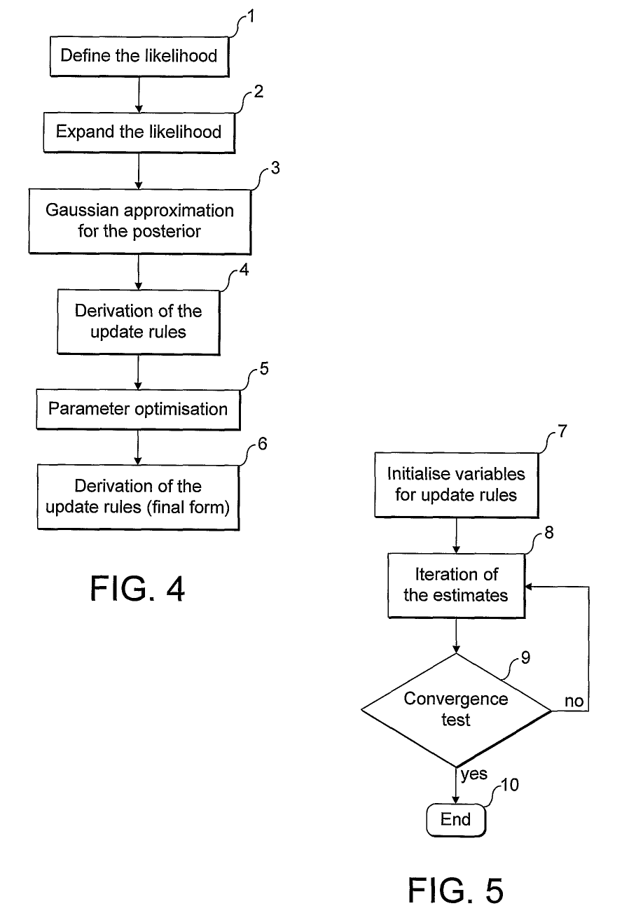

FIG. 4 illustrates an example of a method for deriving a set of update rules. At step 1, the likelihood is defined and this is expanded at step 3, for example as described hereinbefore. At step 3, a Gaussian approximation for the posterior is formed and, at step 4, the set of update rules is derived. At step 5, parameters of the update rules are optimised and a step 6 derives from the optimised parameters a final form of the update rules.

The update rules are then used as illustrated in FIG. 5 to solve the physical problem. At a step 7 the variables for the update rules are initialised. A step 8 commences iteration of the estimates and the result of each estimate is tested for convergence in a step 9. The steps 8 and 9 are repeated until the convergence test is passed, at which point the method ends at 10 by supplying the most probable states or values of the variables. The technique illustrated in FIG. 5 may then be repeated if appropriate for the physical problem being solved.

Although one specific embodiment has been described to illustrate in detail the present invention, it is nevertheless to be understood that this is merely by way of example and that the invention is in fact generally applicable to the processing of signals.

For example in the area of neural networks a known problem is learning (parameter estimation) in the Linear Ising perceptron. In this problem, learning is equivalent to inferring a data set (weights, following the neural networks terminology) encoded in a signal, given a plurality of characteristics of a signal. The Linear Ising perceptron is initialised with a small number of characteristics of a signal and thereby estimates the data set with some probability of error. When additional information is added, the algorithm again estimates the data set, with a reduced probability of error. The learning performance of the perceptron is measured by the improvement in probability of error given the additional information. In this respect, the skilled person is able to formulate the problem in similar terms to the CDMA problem, as described in detail above.

Another example is in the area of lossy data compression. A signal comprises a plurality of characteristics corresponding to an original message. This signal is processed to generate a compressed data set. The size of the compressed data set is smaller than the number of characteristics of the signal. The problem is to infer the compressed data set given the signal and a fixed distortion limit. The original message defines the plurality of signal characteristics while the compressed data set represents the original information to be estimated. Again, an iterative method for estimating the compressed data set could be devised along the lines described for the CDMA signal detection by a skilled person.

1. A method of processing a signal to infer a first data set encoded therein, the method comprising:
measuring a plurality of characteristics of the signal;
establishing a plurality of correlation matrices, each correlation matrix comprising a plurality of correlation values;
generating second and third data sets;
determining an update rule relating each datum of the second and third data sets to each other respective datum of the second and third data sets by way of the measured signal characteristics and properties of the correlation matrices;
applying the update rule to the second and third data sets to obtain updated second and third data sets; and
generating from the updated second and third data sets an output comprising an inferred data set representative of the encoded first data set.

2. The method of processing a signal of claim 1, further comprising applying the update rule to the second and third data sets until the second and third data sets are substantially unchanged.

3. The method of processing a signal of claim 1, further comprising:
determining a plurality of likelihoods, each likelihood comprising the probability of a signal characteristic given the first data set, with respect to a free parameter; and
optimizing the free parameter with respect to a predefined cost measure.

4. The method of processing a signal of claim 3 further comprising determining the plurality of likelihoods in a large number limit.

5. The method of processing a signal of claim 3, further comprising calculating an a posterior estimate using the optimized free parameter.

6. The method of processing a signal of claim 1, wherein the signal is a Code Division Multiple Access (CDMA) signal, the CDMA signal comprising a linear combination of the first data set, a plurality of spreading sequences and a noise sequence, each spreading sequence comprising a respective plurality of spreading chip values.

7. The method of processing a signal of claim 3, wherein the signal is a Code Division Multiple Access (CDMA) signal, the CDMA signal comprising a linear combination of the first data set, a plurality of spreading sequences and a noise sequence, each spreading sequence comprising a respective plurality of spreading chip values, the method further comprising the steps of:
computing macroscopic variables defined by:
$${m}_{μ}^{t} \approx tanh ( {\sum }_{v \neq μ}^{N} {\hat{m}}_{vk}^{t} )$$
$${Q}_{μ k}^{t} \approx \frac{1}{K} {\sum }_{l \neq k} {( {m}_{uk}^{t} )}^{2}$$
$${Y}_{μ k}^{t} \approx \frac{4}{K} {\sum }_{l \neq k} {( {n}_{μ k}^{t} {m}_{μ k}^{t} )}^{2} , \\ {A}^{t} \approx - {\{ \frac{1}{N} {\sum }_{μ = 1}^{N} {y}_{μ}^{2} - β {Q}^{t} \}}^{- 1}$$
where \hat{m}_{νk}^{t} is the mean value at the t-th iteration of the k-th signal bit, μ is the chip sub-index (using a spreading of N chips per bit), K is the number of data in the first data set, N is the spreading factor, n_{μk}^{t} are free parameters that relate to the location of dominant terms of the respective likelihood, β=K/N is the load, and y_{μ} is the μth measured characteristic of the signal;
computing microscopic variables defined by:
$${{m}^{⋒}}_{μ k}^{t + 1} = {{A}^{t} ( \frac{{y}_{μ} {s}_{μ}}{\sqrt{N}} - β ( {P}_{μ} - {K}^{- 1} I ) {m}_{μ}^{t} )}_{k}$$
where s_{μ} is the u-th spreading value, P_{μ,kl}=s_{μ,k}s_{μ,l}, and I is the identity matrix, Iₖₗ=δₖₗ
estimating the k-th bit of the first data set at the t-th iteration as:
$${{b}^{⋒}}_{k}^{t} \approx sgn ( {\sum }_{μ = 1}^{N} {{m}^{⋒}}_{μ k}^{t} ) .$$

8. The method of processing a signal of claim 1, wherein the signal is an output from a Linear Ising perceptron, the signal comprising a linear combination of the first data set, a plurality of inputs to the Linear Ising perceptron and a noise sequence.

9. The method of processing a signal of 1, wherein the signal is an input to a lossy data compression system, the signal comprising a fourth data set, a size of the fourth data set being less than a size of the first data set.

10-13. (canceled)

14. A signal processor comprising:
means for measuring a plurality of characteristics of an input signal;
means for establishing a plurality of correlation matrices, each correlation matrix comprising a plurality of correlation values;
means for generating second and third data sets;
means for determining an update rule relating each datum of the second and third data sets to each other respective datum of the second and third data sets by way of the measured signal characteristics and the properties of the correlation matrices;
means for applying the update rule to the second and third data sets to obtain updated second and third data sets; and
means for generating from the updated second and third data sets an output comprising an inferred data set representative of the encoded first data set.

15. A system comprising:
a decoding system including a signal processor which executed computer readable code for performing the following operations:
measuring a plurality of characteristics of a signal having a first data set encoded therein;
establishing a plurality of correlation matrices, each correlation matrix comprising a plurality of correlation values;
generating second and third data sets;
determining an update rule relating each datum of the second and third data sets to each other respective datum of the second and third data sets by way of the measured signal characteristics and the properties of the correlation matrices;
applying the update rule to the second and third data sets to obtain updated second and third data sets; and
generating from the updated second and third data sets an output comprising an inferred data set representative of the encoded first data set.

16. An inference method for solving a physical problem mapped onto a densely connected graph, where the number of connections per variable is of the same order as the number of variables, comprising:
(a) forming an aggregated system comprising a plurality of replicated systems, each of which is conditioned on a measurement obtained from a physical system, with a correlation matrix representing correlation among the replicated systems;
(b) expanding a probability of the measurements given the solutions obtained by the replicated systems;
(c) based on the expansion of the step (b), deriving a closed set of update rules, which are capable of being calculated iteratively on the basis of results obtained in a previous iteration, for a set of conditional probability messages given the measurements;
(d) optimizing free parameters which emerge from at least one of the steps (b) and (c) for a specific problem examined with respect to a predefined cost measure;
(e) using the optimized parameters to derive an optimized set of update rules for the conditional probability messages given the measurements;
(f) applying the update rules iteratively until they converge to a set of substantially fixed values; and
(g) using the substantially fixed value to determine and generate an output of a most probable state of the variables.
